(19) United States
(12) Patent Application Publication
(10) Pub. No.: US 2008/0209661 A1
(43) Pub. Date: Sep. 4, 2008

(54) Windscreen Wiper Device, in Particular For a Motor Vehicle

(75) Inventors: Andreas Benner, Buehlertal (DE); Tino Boos, Baden-Baden (DE)

Correspondence Address: MICHAEL BEST & FRIEDRICH LLP, 100 EAST WISCONSIN AVENUE, MILWAUKEE, WI, 53202, US

(73) Assignee: ROBERT BOSCH GMBH, Stuttgart (DE)

(21) Appl. No.: 11/995,905

(22) PCT Filed: Jul. 5, 2006
(86) PCT No.: PCT/EP2006/063916

§ 371 Date: Jan. 16, 2008

(30) Foreign Application Priority Data
Jul. 27, 2005 (DE) 102005035088.7

(51) Int. Cl. B60S 1/04

(52) U.S. Cl. 15/250.31

(57) ABSTRACT

A windscreen wiper device (10), in particular for a motor vehicle, is proposed. It comprises a wiper bearing (14) in which is arranged a wiper shaft (16) which is locked against axial displacement by means of a securing means (28). On account of the securing means (28), the wiper shaft (16) can therefore be displaced in the wiper bearing (14) only by means of an axial application of force, so that, if an object or a person impacts against the free end of the wiper shaft (16), the wiper shaft (16) can move away into the wiper bearing (14). According to the invention, it is provided that a locking element (40) in the wiper shaft (16) interacts with the securing means (28), the securing means (28) having extensions (42) which bend or break upon an axial application of force.

### BACKGROUND OF THE INVENTION

The invention relates to a windscreen wiper device, in particular for a motor vehicle, according to the generic type of the independent claim.

Numerous windscreen wiper devices for motor vehicles are already known, the windscreen wiper devices having a wiper bearing in which the wiper shaft, which protrudes from the vehicle body, can be displaced in relation to the wiper bearing by means of an axial application of force. For example, EP-A-0 806 329 shows a windscreen wiper device with a wiper bearing and a wiper shaft, in which the wiper shaft has an encircling groove in which an annular securing means is arranged which secures the wiper shaft against axial displacement. If, in the event of a traffic accident, an object or a person impacts against the wiper shaft or against a wiper arm fastened to the wiper shaft, then the securing means bends and enables the wiper shaft to be displaced axially such that it is capable of moving away into the wiper bearing, and consequently into the interior of the vehicle body.

A crucial factor of such systems is that the axially acting force can be defined in a precise manner, and therefore injuries to an impacting person are largely avoided and, furthermore, the regulations laid down by the legislator are met over the entire service life of the windscreen wiper device.

### SUMMARY OF THE INVENTION

The windscreen wiper device according to the invention has the advantage that the securing means has at least one extension which bends or breaks upon an axial application of force. The extension advantageously enables the application of force, which is necessary for moving the wiper shaft away, to be set more precisely and to remain constant likewise over the service life of the windscreen wiper device. Furthermore, it is particularly advantageous that, after an impact, only the securing means has to be replaced and not the entire windscreen wiper device. Furthermore, it is advantageous that, upon the impact, the wiper bearings remain in their position and only the wiper shafts move away, and therefore only little additional construction space is required in the motor vehicle, since said space only has to accommodate the wiper shafts as they move away.

It is particularly advantageous if the securing means is designed as a part-circular ring and can consequently be fastened on the wiper shaft in a simple manner.

A stable structure is advantageously obtained by the extension extending toward the center of the wiper shaft.

Furthermore, the stability of the structure can be improved by a plurality of extensions, in particular 2, 3 or 4, being provided.

If the extensions extend at regular distances along a circular path of the securing means, which circular path follows the annular shape, then a stable seat is produced for the wiper shaft in the operating state.

A particularly good solution is advantageously obtained in that the extensions have a length, along a circular path following the annular shape, which length is smaller than the length of the part-circular path, in particular is smaller than or equal to half of the length of the part-circular path of the entire securing means.

The securing means can be formed in a simple and cost-effective manner if it is of annular design and is of cuboidal design in at least one, preferably in the entire, cross section. This enables it to be produced particularly cost-effectively, for example in a punching process.

Good radial mobility of the wiper shaft is obtained by the securing means bearing against the wiper bearing directly or indirectly, in particular against a thrust washer.

By means of the securing means being formed from plastic, metal or ceramic, a long service life is obtained for the securing means and, furthermore, the optimum material with the optimum properties with regard to the breaking and bending behavior can be selected in each case for the particular requirements.

### BRIEF DESCRIPTION OF THE DRAWINGS

An exemplary embodiment of the invention is illustrated in the drawings and is explained in more detail in the description below. In the drawings:

FIG. 1 shows a windscreen wiper device according to the invention in a side view,

FIG. 2 shows a wiper bearing of a windscreen wiper device according to the invention in a side view,

FIG. 3 shows the region of the securing means of the windscreen wiper device according to the invention in a cross section,

FIG. 4 shows a region from FIG. 3 in detail,

FIG. 5 shows the detail from FIG. 4 after an impact, and

FIG. 6 shows a securing means of a windscreen wiper device according to the invention in a plan view.

### DETAILED DESCRIPTION

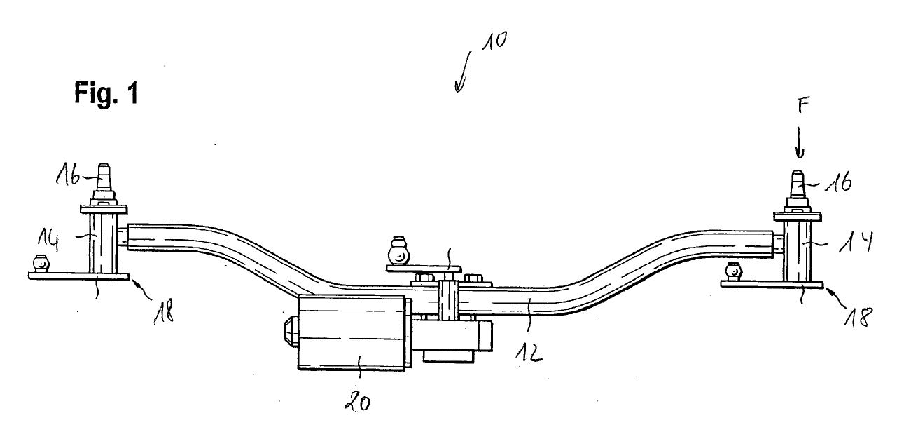

FIG. 1 shows a windscreen wiper device 10 according to the invention in a side view. The windscreen wiper device 10 according to the invention essentially comprises a support tube 12 which has two ends, to each of which a wiper bearing 14 is fastened. A wiper shaft 16, to the free, first end of which a wiper arm can be fastened, is mounted in the wiper bearing 14. At the second end of the wiper shaft 16, a crank 18 is connected to the wiper shaft 16 in a rotationally fixed manner, the crank serving to set the wiper shaft 16 into a swinging movement during operation. Furthermore, a motor 20 which serves for the driving of the windscreen wiper device is fastened to the support tube 12. Motor 20 and crank 18 are connected to each other via connecting rods (not shown here).

When the windscreen wiper device 10 is fitted into a motor vehicle, the first ends of the wiper shafts 16 protrude out of the body of the motor vehicle and support the wiper arms (not shown here). Upon an impact against the wiper arms or directly against the wiper shaft 16, people or other impact bodies may, under some circumstances, be injured or damaged. In order to prevent this, the wiper shaft 16 is fastened in the axial direction in the wiper bearing 14 in such a manner that, upon an axial application of force F, the wiper shaft 16 is capable of moving away into the wiper bearing 14, and consequently into the interior of the vehicle body.

FIG. 2 shows the wiper bearing 14 of a windscreen wiper device 10 according to the invention in a side view. The wiper bearing 14 has a tubular bearing section 22, in the longitudinal extent of which the wiper shaft 16 is arranged coaxially. A fastening section 24 which serves to fasten the wiper bearing 14 to the support tube 12 is provided transversely with respect to the bearing section 22. The crank 18 is fastened in a rotationally fixed manner to the wiper shaft 16 on that side of the wiper shaft 16 which faces away from the free end. Furthermore, the wiper bearing 14 also has a retaining section 26 which serves to fasten the windscreen wiper device 10 to the motor vehicle body. So that the wiper shaft 16 can yield upon application of an axial force F, a securing means 28 is arranged on the wiper shaft on the end side of the bearing section 22, and therefore the wiper shaft 16 is locked axially in the bearing section 22 of the wiper bearing 14 and therefore cannot be displaced. The wiper shaft 16 is therefore completely fixed in the axial direction between the securing means 28 and the crank 18.

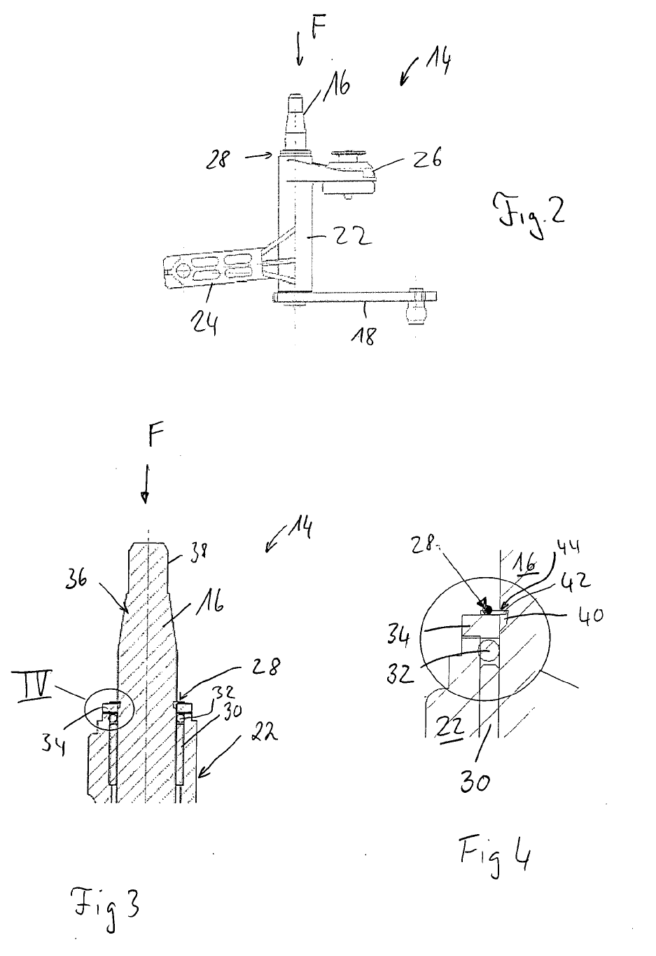

FIG. 3 shows a cross section through the region of the securing means 28 of the bearing section 22 of the wiper bearing 14 and through the wiper shaft 16 in this region in detail. The bearing section 22 essentially comprises a plastic or metal tube into which bearing bushes 30, which are of essentially hollow-cylindrical design and are manufactured from a bearing metal, for example brass, are inserted. Furthermore, in the region of the end side of the bearing section 22, a sealing ring 32 is arranged on the inner wall, the sealing ring extending between wiper shaft 16 and the inner wall of the bearing section 22 in such a manner that moisture is prevented from penetrating the wiper bearing 14. A thrust washer 34 rests on the end side of the bearing section 22. The securing means 28 is punched from steel sheet and is therefore of cuboidal design in cross section. It is fastened to the wiper shaft 16 and rests on that side of the thrust washer 34 which faces away from the bearing section 22.

Furthermore, at its end facing the securing means 28, the wiper shaft 16 has a cone 36 which is closed off by a threaded section 38. During installation, the wiper arm is placed on the cone 36 and is fixed to the threaded section 38 by a screw nut and is consequently connected in a rotationally fixed manner to the wiper shaft 16.

FIG. 4 illustrates the region of the securing means 28 of the wiper bearing from FIG. 3 on an enlarged scale. The bearing bush 30 is inserted into the interior of the tubular bearing section 22 and supports the wiper shaft 16. The sealing ring 32 is inserted in the interior of the bearing section 22 on that side of the bearing section 22 which faces the securing means 28. The end side of the bearing section 22 is closed off by the thrust washer 34.

The wiper shaft 16 has a locking element 40 which is designed as an encircling groove. An extension 42 of the securing means 28 engages in said locking element 40 such that the wiper shaft 16 is secured against axial displacement in the direction of the sealing ring 32 and of the bearing bush 22. In this connection, the locking element 40 or the groove 40 has an edge 44 against which the extension 42 bears. The edge 44 is formed by a side wall of the groove 40 and the outer boundary of the wiper shaft 16 and encloses an angle of 90° in relation to the outer boundary of the wiper shaft 16 in the region of the free first end.

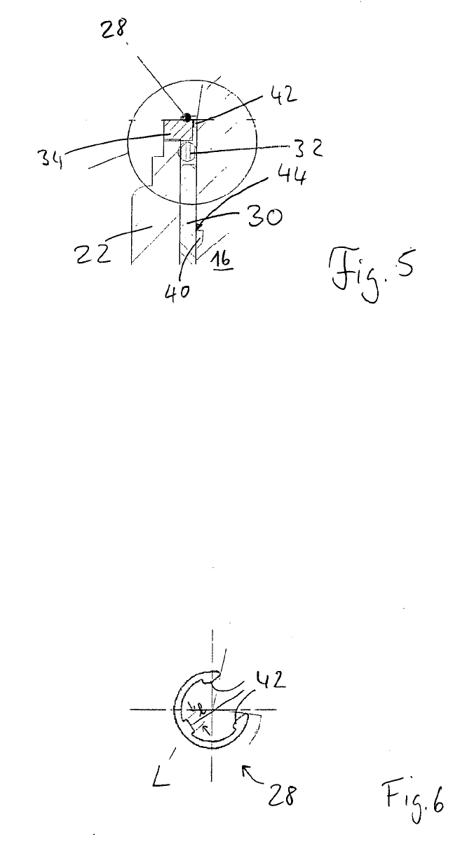

FIG. 5 shows the same enlargement from FIG. 4, but after an axial application of force F. The extension 42 has been bent by the penetration of the wiper shaft 16 into the bearing section 22 and now protrudes between wiper shaft 16 and thrust washer 34 in the direction of the bearing section 22. The locking element 40 with the edge 44 is now displaced into the region of the bearing bush 30.

The securing means 28 is designed as a part-circular washer, the inside diameter of which approximately corresponds to the outside diameter of the wiper shaft 16. The extensions 42 protrude into the wiper shaft 16 in the direction of the center of the wiper shaft 16. The thrust washer 34 is dimensioned here in such a manner that the inside diameter of the thrust washer 34, added to the thickness of the extension 42, approximately corresponds to the outside diameter of the wiper shaft, and therefore, when the extension 42 is bent, the wiper shaft 16 can move away into the bearing section 22 of the wiper bearing 14. If it is provided that the extension 42 is to break in the event of an axial application of force F, then the inside diameter of the thrust washer 34 can also be approximately the same size as the outside diameter of the wiper shaft 16.

FIG. 6 shows the securing means 28 in detail in a plan view. The securing means 28 is of part-circular design and has extensions 42 protruding inward into the center of the part-circle. In this case, the extensions 42 are arranged at regular distances on a part-circular path which corresponds to the annular shape of the disk-shaped securing means 28. The overall length of the disk-shaped securing means 28 corresponds to the part-circular path section which is described by the annular securing means 28. Furthermore, the sum of the lengths of the extensions 42 along said part-circular path is smaller than or equal to half the overall length of the securing means 28. The securing means 28 is designed here as a thin sheet-metal disk and therefore as a simple punched part. The thickness of the securing means 28 is between 0.5 and 1.5 mm, in particular approximately 1 mm. In one variation, the securing means 28 may, of course, also be formed from ceramic or from plastic and then be of correspondingly thinner or thicker design.

In one variation, the extensions 42 may also be designed in such a manner that they break. In particular in this case, the edge 44 (FIG. 5) is also provided with an angle which is smaller than 90° with respect to the free end of the wiper shaft, thus producing a shearing-off effect at the extension 42. In this case, it is then also possible for the inside diameter of the thrust washer 34 to essentially correspond to the outside diameter of the wiper shaft 16. In one variation, the thrust washer 34 can also have, at least in the region of the extension 42, a structure which assists shearing off or bending, for example a knurled structure. In order to assist bending of the extension 42, the angle of the edge 44 can also be more than 90°.

In a further variation, it is also possible not to design the locking element 40 as an encircling groove but rather merely to provide corresponding cutouts in the wiper shaft 16, into which the tab-like extensions 42 can engage. In a further variation, of course, not only three extensions, but also just 2 or 4 or more extensions 42 can be provided. The extensions penetrate approximately 0.5 to 4 mm, preferably 0.5 to 3 mm, in particular 0.5 to 2 mm, into the wiper shaft 16. In a further variation, the extensions 42 can also penetrate only up to 1 mm into the wiper shaft 16.

### PRIOR ART

The invention relates to a windscreen wiper device, in particular for a motor vehicle, according to the generic type of the independent claim.

Numerous windscreen wiper devices for motor vehicles are already known, the windscreen wiper devices having a wiper bearing in which the wiper shaft, which protrudes from the vehicle body, can be displaced in relation to the wiper bearing by means of an axial application of force. For example, EP-A-0 806 329 shows a windscreen wiper device with a wiper bearing and a wiper shaft, in which the wiper shaft has an encircling groove in which an annular securing means is arranged which secures the wiper shaft against axial displacement. If, in the event of a traffic accident, an object or a person impacts against the wiper shaft or against a wiper arm fastened to the wiper shaft, then the securing means bends and enables the wiper shaft to be displaced axially such that it is capable of moving away into the wiper bearing, and consequently into the interior of the vehicle body.

A crucial factor of such systems is that the axially acting force can be defined in a precise manner, and therefore injuries to an impacting person are largely avoided and, furthermore, the regulations laid down by the legislator are met over the entire service life of the windscreen wiper device.

### Advantages of the Invention

The windscreen wiper device according to the invention with the features of the main claim has the advantage that the securing means has at least one extension which bends or breaks upon an axial application of force. The extension advantageously enables the application of force, which is necessary for moving the wiper shaft away, to be set more precisely and to remain constant likewise over the service life of the windscreen wiper device. Furthermore, it is particularly advantageous that, after an impact, only the securing means has to be replaced and not the entire windscreen wiper device. Furthermore, it is advantageous that, upon the impact, the wiper bearings remain in their position and only the wiper shafts move away, and therefore only little additional construction space is required in the motor vehicle, since said space only has to accommodate the wiper shafts as they move away.

The measures cited in the subclaims give rise to advantageous developments and improvements of the features specified in the main claim.

It is particularly advantageous if the securing means is designed as a part-circular ring and can consequently be fastened on the wiper shaft in a simple manner.

A stable structure is advantageously obtained by the extension extending toward the center of the wiper shaft.

Furthermore, the stability of the structure can be improved by a plurality of extensions, in particular 2, 3 or 4, being provided.

If the extensions extend at regular distances along a circular path of the securing means, which circular path follows the annular shape, then a stable seat is produced for the wiper shaft in the operating state.

A particularly good solution is advantageously obtained in that the extensions have a length, along a circular path following the annular shape, which length is smaller than the length of the part-circular path, in particular is smaller than or equal to half of the length of the part-circular path of the entire securing means.

The securing means can be formed in a simple and cost-effective manner if it is of annular design and is of cuboidal design in at least one, preferably in the entire, cross section. This enables it to be produced particularly cost-effectively, for example in a punching process.

Good radial mobility of the wiper shaft is obtained by the securing means bearing against the wiper bearing directly or indirectly, in particular against a thrust washer.

By means of the securing means being formed from plastic, metal or ceramic, a long service life is obtained for the securing means and, furthermore, the optimum material with the optimum properties with regard to the breaking and bending behavior can be selected in each case for the particular requirements.

### DRAWINGS

An exemplary embodiment of the invention is illustrated in the drawings and is explained in more detail in the description below. In the drawings:

FIG. 1 shows a windscreen wiper device according to the invention in a side view,

FIG. 2 shows a wiper bearing of a windscreen wiper device according to the invention in a side view,

FIG. 3 shows the region of the securing means of the windscreen wiper device according to the invention in a cross section,

FIG. 4 shows a region from FIG. 3 in detail,

FIG. 5 shows the detail from FIG. 4 after an impact, and

FIG. 6 shows a securing means of a windscreen wiper device according to the invention in a plan view.

### DESCRIPTION OF THE EXEMPLARY EMBODIMENT

FIG. 1 shows a windscreen wiper device 10 according to the invention in a side view. The windscreen wiper device 10 according to the invention essentially comprises a support tube 12 which has two ends, to each of which a wiper bearing 14 is fastened. A wiper shaft 16, to the free, first end of which a wiper arm can be fastened, is mounted in the wiper bearing 14. At the second end of the wiper shaft 16, a crank 18 is connected to the wiper shaft 16 in a rotationally fixed manner, the crank serving to set the wiper shaft 16 into a swinging movement during operation. Furthermore, a motor 20 which serves for the driving of the windscreen wiper device is fastened to the support tube 12. Motor 20 and crank 18 are connected to each other via connecting rods (not shown here).

When the windscreen wiper device 10 is fitted into a motor vehicle, the first ends of the wiper shafts 16 protrude out of the body of the motor vehicle and support the wiper arms (not shown here). Upon an impact against the wiper arms or directly against the wiper shaft 16, people or other impact bodies may, under some circumstances, be injured or damaged. In order to prevent this, the wiper shaft 16 is fastened in the axial direction in the wiper bearing 14 in such a manner that, upon an axial application of force F, the wiper shaft 16 is capable of moving away into the wiper bearing 14, and consequently into the interior of the vehicle body.

FIG. 2 shows the wiper bearing 14 of a windscreen wiper device 10 according to the invention in a side view. The wiper bearing 14 has a tubular bearing section 22, in the longitudinal extent of which the wiper shaft 16 is arranged coaxially. A fastening section 24 which serves to fasten the wiper bearing 14 to the support tube 12 is provided transversely with respect to the bearing section 22. The crank 18 is fastened in a rotationally fixed manner to the wiper shaft 16 on that side of the wiper shaft 16 which faces away from the free end. Furthermore, the wiper bearing 14 also has a retaining section 26 which serves to fasten the windscreen wiper device 10 to the motor vehicle body. So that the wiper shaft 16 can yield upon application of an axial force F, a securing means 28 is arranged on the wiper shaft on the end side of the bearing section 22, and therefore the wiper shaft 16 is locked axially in the bearing section 22 of the wiper bearing 14 and therefore cannot be displaced. The wiper shaft 16 is therefore completely fixed in the axial direction between the securing means 28 and the crank 18.

FIG. 3 shows a cross section through the region of the securing means 28 of the bearing section 22 of the wiper bearing 14 and through the wiper shaft 16 in this region in detail. The bearing section 22 essentially comprises a plastic or metal tube into which bearing bushes 30, which are of essentially hollow-cylindrical design and are manufactured from a bearing metal, for example brass, are inserted. Furthermore, in the region of the end side of the bearing section 22, a sealing ring 32 is arranged on the inner wall, the sealing ring extending between wiper shaft 16 and the inner wall of the bearing section 22 in such a manner that moisture is prevented from penetrating the wiper bearing 14. A thrust washer 34 rests on the end side of the bearing section 22. The securing means 28 is punched from steel sheet and is therefore of cuboidal design in cross section. It is fastened to the wiper shaft 16 and rests on that side of the thrust washer 34 which faces away from the bearing section 22.

Furthermore, at its end facing the securing means 28, the wiper shaft 16 has a cone 36 which is closed off by a threaded section 38. During installation, the wiper arm is placed on the cone 36 and is fixed to the threaded section 38 by a screw nut and is consequently connected in a rotationally fixed manner to the wiper shaft 16.

FIG. 4 illustrates the region of the securing means 28 of the wiper bearing from FIG. 3 on an enlarged scale. The bearing bush 30 is inserted into the interior of the tubular bearing section 22 and supports the wiper shaft 16. The sealing ring 32 is inserted in the interior of the bearing section 22 on that side of the bearing section 22 which faces the securing means 28. The end side of the bearing section 22 is closed off by the thrust washer 34.

The wiper shaft 16 has a locking element 40 which is designed as an encircling groove. An extension 42 of the securing means 28 engages in said locking element 40 such that the wiper shaft 16 is secured against axial displacement in the direction of the sealing ring 32 and of the bearing bush 22. In this connection, the locking element 40 or the groove 40 has an edge 44 against which the extension 42 bears. The edge 44 is formed by a side wall of the groove 40 and the outer boundary of the wiper shaft 16 and encloses an angle of 90° in relation to the outer boundary of the wiper shaft 16 in the region of the free first end.

FIG. 5 shows the same enlargement from FIG. 4, but after an axial application of force F. The extension 42 has been bent by the penetration of the wiper shaft 16 into the bearing section 22 and now protrudes between wiper shaft 16 and thrust washer 34 in the direction of the bearing section 22. The locking element 40 with the edge 44 is now displaced into the region of the bearing bush 30.

The securing means 28 is designed as a part-circular washer, the inside diameter of which approximately corresponds to the outside diameter of the wiper shaft 16. The extensions 42 protrude into the wiper shaft 16 in the direction of the center of the wiper shaft 16. The thrust washer 34 is dimensioned here in such a manner that the inside diameter of the thrust washer 34, added to the thickness of the extension 42, approximately corresponds to the outside diameter of the wiper shaft, and therefore, when the extension 42 is bent, the wiper shaft 16 can move away into the bearing section 22 of the wiper bearing 14. If it is provided that the extension 42 is to break in the event of an axial application of force F, then the inside diameter of the thrust washer 34 can also be approximately the same size as the outside diameter of the wiper shaft 16.

FIG. 6 shows the securing means 28 in detail in a plan view. The securing means 28 is of part-circular design and has extensions 42 protruding inward into the center of the part-circle. In this case, the extensions 42 are arranged at regular distances on a part-circular path which corresponds to the annular shape of the disk-shaped securing means 28. The overall length of the disk-shaped securing means 28 corresponds to the part-circular path section which is described by the annular securing means 28. Furthermore, the sum of the lengths of the extensions 42 along said part-circular path is smaller than or equal to half the overall length of the securing means 28. The securing means 28 is designed here as a thin sheet-metal disk and therefore as a simple punched part. The thickness of the securing means 28 is between 0.5 and 1.5 mm, in particular approximately 1 mm. In one variation, the securing means 28 may, of course, also be formed from ceramic or from plastic and then be of correspondingly thinner or thicker design.

In one variation, the extensions 42 may also be designed in such a manner that they break. In particular in this case, the edge 44 (FIG. 5) is also provided with an angle which is smaller than 90° with respect to the free end of the wiper shaft, thus producing a shearing-off effect at the extension 42. In this case, it is then also possible for the inside diameter of the thrust washer 34 to essentially correspond to the outside diameter of the wiper shaft 16. In one variation, the thrust washer 34 can also have, at least in the region of the extension 42, a structure which assists shearing off or bending, for example a knurled structure. In order to assist bending of the extension 42, the angle of the edge 44 can also be more than 90°.

In a further variation, it is also possible not to design the locking element 40 as an encircling groove but rather merely to provide corresponding cutouts in the wiper shaft 16, into which the tab-like extensions 42 can engage. In a further variation, of course, not only three extensions, but also just 2 or 4 or more extensions 42 can be provided. The extensions penetrate approximately 0.5 to 4 mm, preferably 0.5 to 3 mm, in particular 0.5 to 2 mm, into the wiper shaft 16. In a further variation, the extensions 42 can also penetrate only up to 1 mm into the wiper shaft 16.

1. A windscreen wiper device, with a wiper bearing (14) in which a wiper shaft (16) is arranged which is locked against axial displacement by means of at least one securing means (28) arranged on the wiper shaft (16), and therefore the wiper shaft (6) can be displaced in relation to the wiper bearing (14) only by an axial application of force (F), the wiper shaft (16) having at least one locking element (40), which interacts with the securing means (28), characterized in that the securing means (28) has at least one extension (42) which bends or breaks upon an axial application of force (F).

2. The windscreen wiper device as claimed in claim 1, characterized in that the securing means (28) is designed as a part-circular ring.

3. The windscreen wiper device as claimed in claim 1, characterized in that the extension (42) extends toward the center of the wiper shaft (16).

4. The windscreen wiper device as claimed in claim 1, characterized in that a plurality of extensions, are provided.

5. The windscreen wiper device as claimed in claim 1, characterized in that the securing means (28) is of at least partially annular design and the extensions (42) are arranged at regular distances along a part-circular path following the annular shape.

6. The windscreen wiper device as claimed in claim 1, characterized in that the securing means (28) is of at least partially annular design and the extension (42) has a length (1), along a part-circular path following the annular shape, which length is smaller than the length (L) of the part-circular path of the entire securing means (28).

7. The windscreen wiper device as claimed in claim 1, characterized in that the securing means (28) is of annular design and is of cuboidal design in cross section.

8. The windscreen wiper device as claimed in claim 1, characterized in that the securing means (28) bears against the wiper bearing (14) indirectly.

9. The windscreen wiper device as claimed in claim 1, characterized in that the securing means (28) is designed as a punched part.

10. The windscreen wiper device as claimed in claim 1, characterized in that the securing means (28) is formed from plastic, metal or ceramic.

11. The windscreen wiper device as claimed in claim 2, characterized in that the extension (42) extends toward the center of the wiper shaft (16).

12. The windscreen wiper device as claimed in claim 11, characterized in that 2, 3 or 4 extensions, are provided.

13. The windscreen wiper device as claimed in claim 12, characterized in that the securing means (28) is of at least partially annular design and the extensions (42) are arranged at regular distances along a part-circular path following the annular shape.

14. The windscreen wiper device as claimed in claim 13, characterized in that the securing means (28) is of at least partially annular design and the extensions (42) have a length (1), along a part-circular path following the annular shape, which length is smaller than or equal to half of the length (L) of the part-circular path of the entire securing means (28).

15. The windscreen wiper device as claimed in claim 14, characterized in that the securing means (28) is of annular design and is of cuboidal design in cross section.

16. The windscreen wiper device as claimed in claim 15, characterized in that the securing means (28) bears against the wiper bearing (14) indirectly, against a thrust washer.

17. The windscreen wiper device as claimed in claim 16, characterized in that the securing means (28) is designed as a punched part.

18. The windscreen wiper device as claimed in claim 17, characterized in that the securing means (28) is formed from plastic, metal or ceramic.

19. The windscreen wiper device as claimed in claim 1, characterized in that the locking element (40) includes a groove.

20. The windscreen wiper device as claimed in claim 1, characterized in that the securing means (28) is of at least partially annular design and the extension (42) has a length (1), along a part-circular path following the annular shape, which length is smaller than or equal to half of the length (L) of the part-circular path of the entire securing means (28).

21. The windscreen wiper device as claimed in claim 1, characterized in that the securing means (28) bears against the wiper bearing (14) indirectly, against a thrust washer.
